(19) United States
(12) Patent Application Publication
(10) Pub. No.: US 2017/0090842 A1
(43) Pub. Date: Mar. 30, 2017

(54) INFORMATION TERMINAL DEVICE AND DISPLAY APPARATUS

(71) Applicant: TOSHIBA TEC KABUSHIKI KAISHA, Tokyo (JP)

(72) Inventor: Katsuya Sasahara, Izu (JP)

(21) Appl. No.: 14/867,164

(22) Filed: Sep. 28, 2015

(51) Int. Cl. G06F 3/147; G09G 5/00

(52) U.S. Cl. CPC G06F 3/147; G09G 5/006

(57) ABSTRACT

In accordance with an embodiment, an information terminal device provided with a display screen section comprises a flat optical element plate the bottom surface of which is stuck fast to and arranged on the surface of the display screen section to shift the image displayed on the display screen section towards a specific direction and display the shifted image on the top surface of the flat optical element plate as an erected unmagnification image.

### FIELD

Embodiments described herein relate to the practical use of a flat display.

### BACKGROUND

Conventionally, a display apparatus having a display screen such as an LCD (Liquid Crystal Display) panel is provided with an external frame surrounding the LCD panel.

Generally, an electronic image processing can be carried out by displaying a continuous image on display screens of two LCD display devices arranged in a row (hereinafter referred to as ‘two-screen display screen’).

However, the two display devices which are arranged in a row are both provided with an external frame surrounding the display screen thereof. The external frames for separating the two display screens degrade the appearance of the image displayed on the two-screen display screen.

Therefore, it is desired to display an image on a two-screen display screen seamlessly.

### BRIEF DESCRIPTION OF THE DRAWINGS

FIG. 1 is a plan view illustrating a developed display apparatus according to embodiment 1;

FIG. 2 is a sectional view of the display apparatus seen from the arrow direction of the A-A line of FIG. 1;

FIG. 3 is a diagram illustrating the shift of the display apparatus from a developed state shown in FIG. 1 to a closed state;

FIG. 4 is a diagram illustrating the principle of an equivalent magnification imaging optical element;

FIG. 5 is a diagram illustrating the principle of an optical element plate for shifting an imaging position using the equivalent magnification imaging optical element shown in FIG. 4;

FIG. 6 is a diagram illustrating the display of an image on a two-screen display screen;

FIG. 7 is a block diagram illustrating the image display circuit of the display apparatus shown in FIG. 1;

FIG. 8 is a flowchart illustrating the display processing on a two-screen display screen using the image display circuit shown in FIG. 7; and

FIG. 9 is a diagram illustrating a display apparatus according to embodiment 2.

### DETAILED DESCRIPTION

Generally, the information terminal device according to embodiments described herein is an information terminal device provided with a display screen section. The information terminal device comprises a flat optical element plate the bottom surface of which is stuck fast to and arranged on the surface of the display screen section to shift the image displayed on the display screen section towards a specific direction and display the shifted image on the top surface of the flat optical element plate as an erected unmagnification image.

Generally, the display apparatus according to embodiments described herein is a display apparatus which forms a two-screen display screen by connecting two information terminal devices. The display apparatus comprises a first information terminal device provided with a first flat optical element plate the bottom surface of which is stuck fast to and arranged on the surface of a first display screen section to shift the image displayed on the first display screen section towards an opposite connected terminal device and display the shifted image on the top surface of the first flat optical element plate as an erected unmagnification image; and a second information terminal device provided with a second flat optical element plate the bottom surface of which is stuck fast to and arranged on the surface of the second display screen section to shift the image displayed on a second display screen section towards a connected opposite terminal device and display the shifted image on the top surface of the second flat optical element plate as an erected unmagnification image.

The display apparatus according to embodiments described herein is described below in detail with reference to the accompanying drawings.

### Embodiment 1

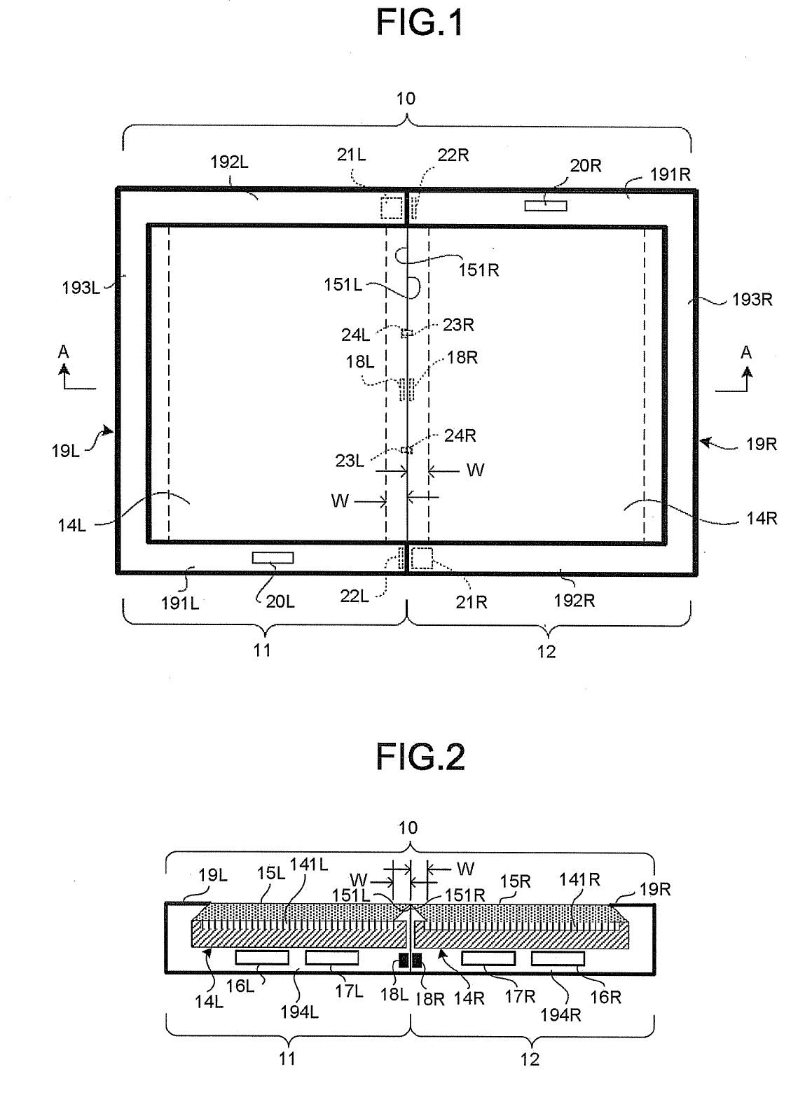

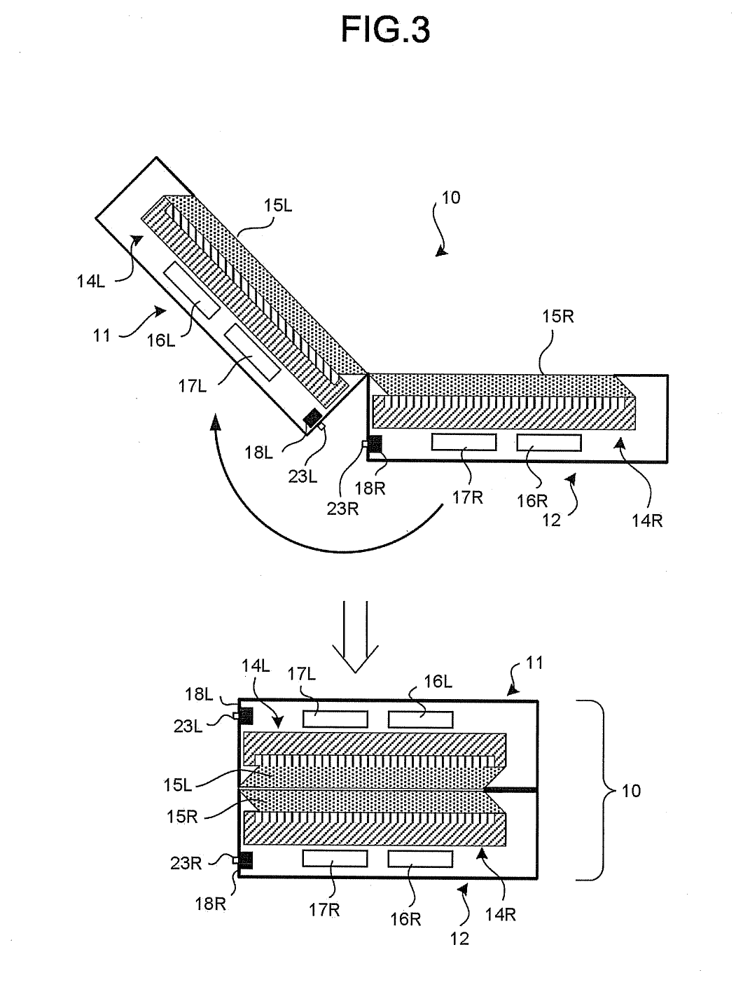

FIG. 1 is a plan view illustrating a developed display apparatus according to embodiment 1. FIG. 2 is a sectional view of the display apparatus seen from the arrow direction of the A-A line of FIG. 1. FIG. 3 is a diagram illustrating the shift of the display apparatus from a developed state shown in FIG. 1 to a closed state.

In FIG. 1, a display apparatus 10 is constituted by connecting, using a hinge member (not shown), a first information terminal device 11 and a second information terminal device 12 which have the same structure.

As the first information terminal device 11 and the second information terminal device 12 have the same structure, only the first information terminal device 11 is described, and the second information terminal device is the same as the material which explained in the first information terminal device 11, Therefor saving the description of the second information terminal device 12. The information terminal device may be a machine capable of accessing information, such as a smart phone, a slate terminal and a tablet terminal.

An LCD panel section 14L, a control section 16L, a power supply battery 17L and the like are arranged in a case member 19L of the first information terminal device 11. A display screen section 141L having a rectangular plane is arranged on the top of the LCD panel section 14L to display an image.

The case member 19L has a lower short side section 191L and a upper short side section 192L which are arranged in parallel and a long side section 193L which connects the left ends of the lower short side section 191L and the upper short side section 192L and further a bottom side section 194L.

The first information terminal device 11 takes the lower short side section 191L as a nearer side and displays an image on the display screen section 141L. An operating switch 20L is arranged on the lower short side section 191L.

An erected unmagnification image imaging optical element 15L is stuck fast to and arranged on the surface of the display screen section 141L. The erected unmagnification image imaging optical element 15L has a rectangular plane, and is formed into a rhombus inclined to the right lateral side in FIG. 2. The upper right lateral side (hereinafter referred to as ‘butt end edge’) of the erected unmagnification image imaging optical element 15L reaches the right lateral side of the first information terminal device 11, and the lower right lateral side of the erected unmagnification image imaging optical element 15L reaches the right lateral side of the display screen section 141L. Here, the length of the butt end edge 151L protruded to the right from the lower right lateral side is set to be W.

The erected unmagnification image imaging optical element 15L is characterized in shifting the whole image displayed on the display screen section 141L stuck fast to the bottom surface of the erected unmagnification image imaging optical element 15L to the right by a distance W and then displaying the image. The erected unmagnification image imaging optical element 15L is hereinafter referred to as an ‘image shifting optical plate’.

In the present embodiment, the second information terminal device 12 in a vertically reversed state is connected with the first information terminal device 11. In this case, as shown in FIG. 2, the butt end edge 151L of the image shifting optical plate 15L of the first information terminal device 11 is seamlessly butted against the butt end edge 151R of the image shifting optical plate 15R of the second information terminal device 12.

A positioning projection section 23L, a positioning engagement hole section 24L and a terminal section 18L electrically connected with the second information terminal device 12 are formed on the right side of the casing member 19L. The terminal section 18L is arranged in the center of the long side, and the positioning projection section 23L and the positioning engagement hole section 24L are arranged at a same distance spaced from the terminal section 18L across the terminal section 18L. A magnet 21L is arranged on the right end of the upper short side section 192L of the casing member 19L, and a metal sheet 22L is arranged on the right end of the lower short edge section 191L of the casing member 19L.

Thus, the positioning projection section 23L is engaged with the opposite side positioning engagement hole section 24R when the first information terminal device 11 and the second information terminal 12 are developed and connected in a plane, as shown in FIG. 1 and FIG. 2, and similarly, a projection section 23R is engaged with an engagement hole section 24L, thereby performing a positioning in the longitudinal (vertical) direction. Further, the magnets 21L and 21R attract the metal sheets 22R and 22L, respectively, thereby keeping the display apparatus developed in a plane.

Further, when the display apparatus 10 is not used, for example, as shown in FIG. 3, the first information terminal 11 and the second information terminal 12 may be folded by a hinge member (not shown).

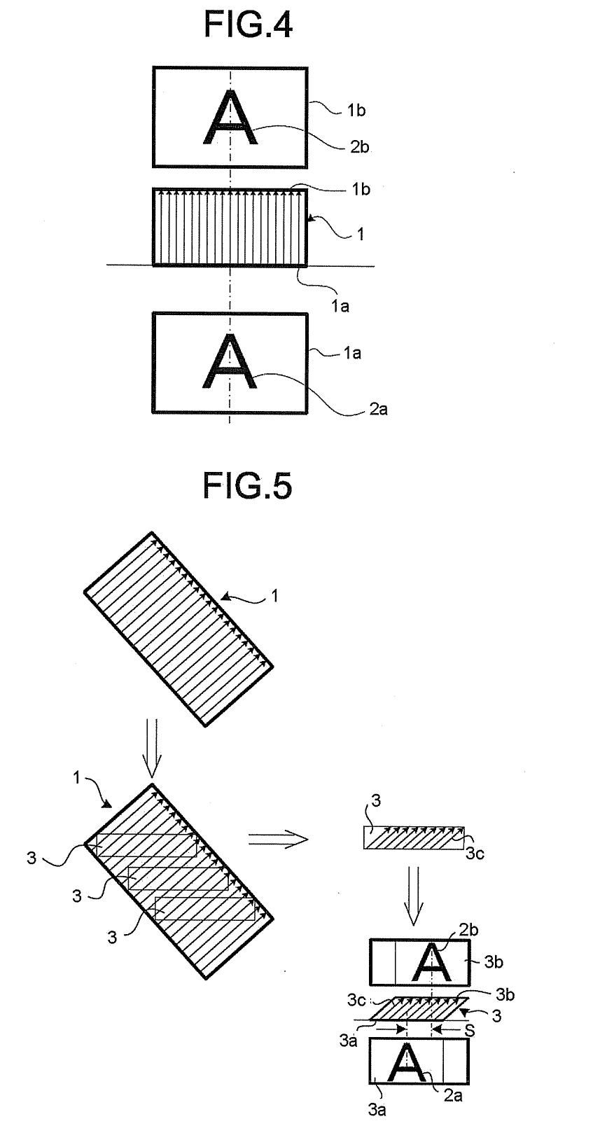

The character of the image shifting optical plate 15L is described below with reference to FIG. 4 and FIG. 5.

The image shifting optical plate 15L uses an optical element made from a well-known Ulexite or SELFOC (registered trademark). The optical element 1 is an optical system which forms an erected unmagnification image on a bottom surface 1a thereof if the bottom surface 1a is stuck and placed on the image ‘A’ 2a drawn on a sheet. The Ulexite is the aggregation array of completely parallel transparent fibrous crystals composed of NaCaB5O6.5H2O. The image light of the image 2a is totally and repeatedly reflected in each fiber (glass fiber) of the artificially synthesized sufficient selfoc lens array to a top surface 1b. At this time, the image light advances in the straight optical path from the bottom surface 1a to the top surface 1b. Thus, the image 2b in the top surface 1b which is an erected unmagnification image can be seen as the image imaged on the top surface 1b. In FIG. 4 and FIG. 5, the direction indicated by the arrow represents the optical path of image light in each glass fiber, and the lateral sides of the glass fiber is impervious to light.

FIG. 5 is a diagram illustrating the principle of the image shifting optical plate 15L using the optical element 1 having the aforementioned character. Apparently, the image shifting optical plate 15L is not limited to be formed in this way.

In FIG. 5, a board material 3 having a specific thickness in the horizontal direction is cut from the inclined optical element 1. In the cut board material 3 having a rectangular cross-sectional shape, the fiber 3c indicated by the arrow is inclined with respect to the bottom surface. By cutting the left and the right end side of the board material 3 and processing the board material 3 into a rhombus, a rhombus board material 3 is obtained. For example, if the rhombus board material 3 is placed on the image ‘A’ 2a drawn on the sheet, the image right of the image 2a stuck fast to the bottom surface 3a advances along the fiber 3c, thereby shifting an image 2b imaged on the top surface 3b of the board material by a distance S. In the embodiment, the shift distance S of the image is set to be W.

Further, although the section of the image shifting optical plate 15L/R is formed into a rhombus, the section may also be formed into a quadrangle.

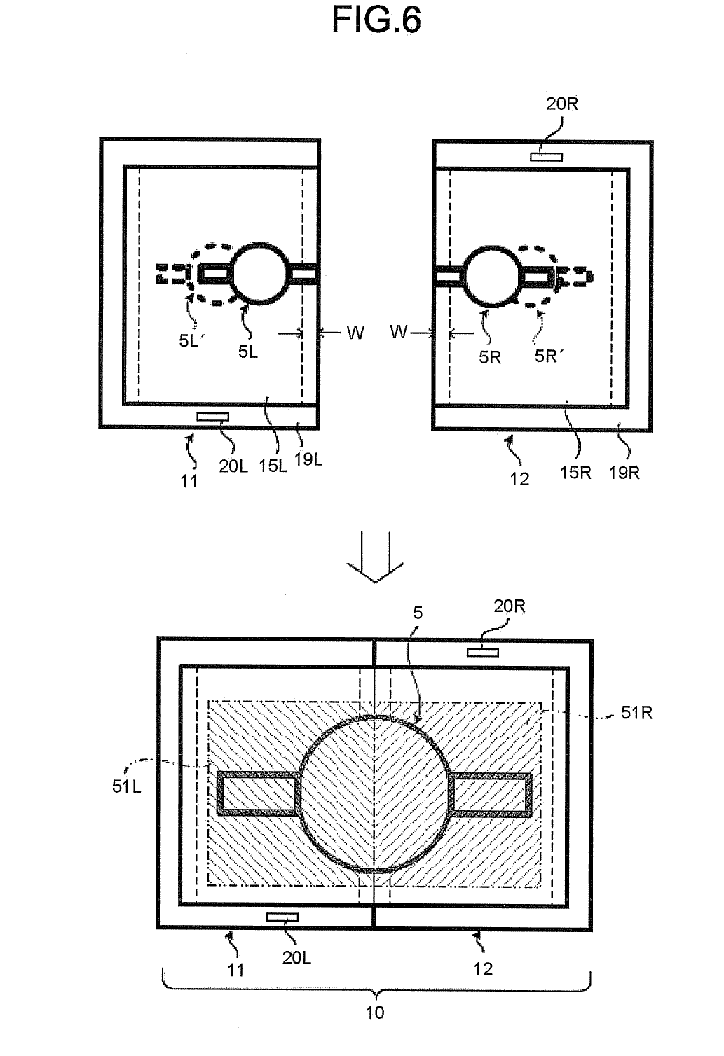

FIG. 6 shows the display of an image on a screen when the first information terminal device 11 is separated from the second information terminal device 12 and the display of an image on a two-screen display screen when the first information terminal device 11 is connected with the second information terminal device 12. In the “one image displayed on single screen mode”, for images 5L′ and 5R′ displayed on the display screen sections 141L and 141R, the images 5L and 5R imaged on the surfaces of the image shifting optical plates 15L and 15R are shifted by the distance W and then displayed. If the first information terminal device 11 is connected with the second information terminal device 12 and the terminal sections 18L and 18R are connected with each other, then the display mode is switched to a “one image displayed on two screens mode” in which the images 5 are joined into a large-size image and then displayed. In this case, the image shifting optical plates 15L and 15R are seamlessly butted against each other in the long side direction, thus, the left-half image (the first half-image) 51L of the image 5 is displayed on the first information terminal device 11, and the right-half image (the second half-image) 51R is displayed on the second information terminal device 12. At this time, the image 5 is displayed in the following manner that the display positions of the first half-image 51L and the second half-image 51R are connected at the positions of the butt end edges 151L and 151R of the image shifting optical plates 15L and 15R.

Although the first information terminal device 11 is described as a master device and the second information terminal device 12 as a slave device, the present invention is not limited to this, the second information terminal device 12 may serve as a master device and the first information terminal device 11 as a slave device. For example, after the first information terminal device 11 is connected with the second information terminal device 12, for example, if the operating switch 20L is operated, then the first information terminal device 11 serves as a master information terminal device and the second information terminal device 12 as a slave information terminal device. Thus, as shown in FIG. 6, the first information terminal device 11 serving as a master information terminal device outputs an erected image. With respect to this, the second information terminal device 12 serving as a slave information terminal device outputs an inverted image.

Further, the voltages (remaining amount) of the batteries 17L of the first information terminal device 11 and the second information terminal device 12 are usually different. In the present embodiment, there is a power feeding determination section which determines to feed the power from a battery having high voltage (a battery higher in residual quantity) to a battery having low-voltage (a battery lower in residual quantity). Thus, even if images are continuously displayed based on the two-screen display screen mode, the two information terminal devices can display the images with the batteries thereof having the same voltage (having the same residual quantity).

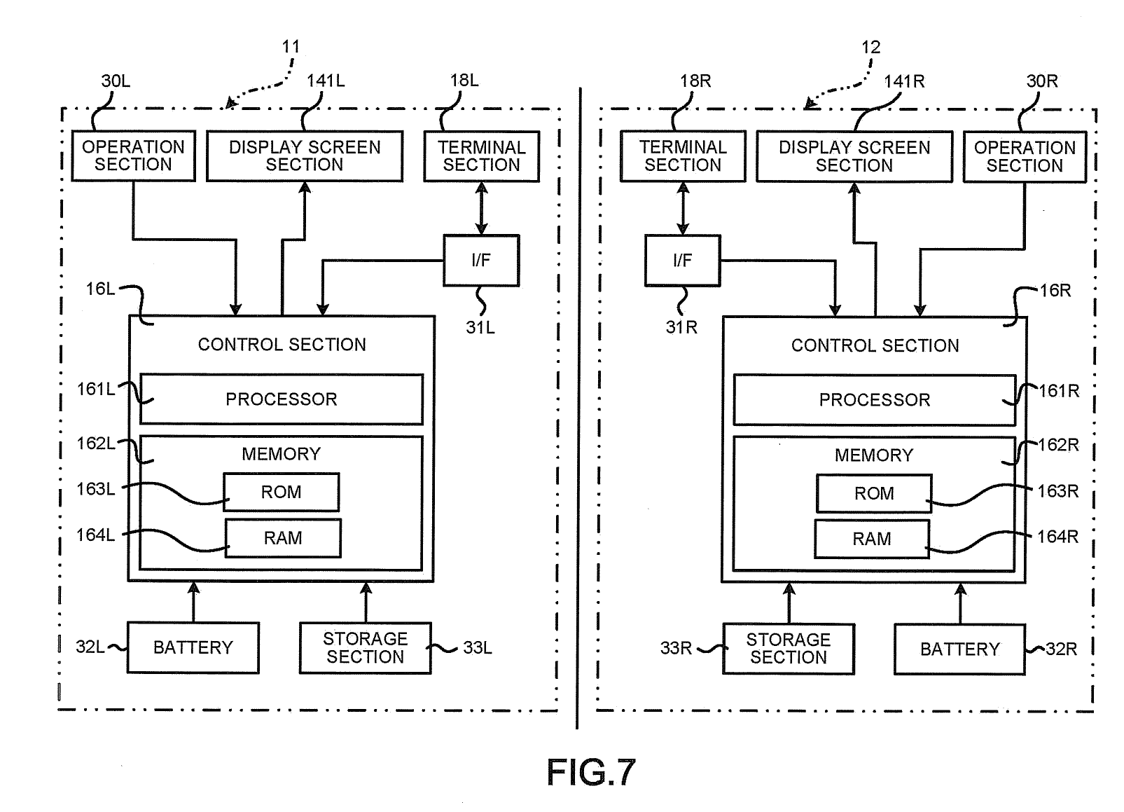

FIG. 7 is a block diagram illustrating image display circuits of the first information terminal device 11 and the second information terminal device 12. As the image display circuits of the first information terminal device 11 and the second information terminal device 12 have the same structure, only the first information terminal device 11 is described here, and a reference symbol ended with L denoting a component of the first information terminal device 11 is ended with R to denote a corresponding component of the second information terminal device 12, thereby saving the description of the image display circuit of the second information terminal device 12.

The first information terminal device 11 comprises an operation section 30L such as an operating switch 20L and the like, a display screen section 141L, a terminal section 18L including a power feeding terminal, an interface (I/F) section 31L, a control section 16L, a battery 32L and a storage section 33L.

The control section (controller) 16L comprises a processor 161L consisting of a CPU (Central Processing Unit) or an MPU (Micro Processing Unit) and a memory 162L. The processor 161L displays the information stored in the memory 162L and the storage section 33L on the display screen section 141L based on the input information from the operation section 30L and the I/F 31L.

The memory 162L, for example, which is a semiconductor memory, has an ROM (Read Only Memory) 163L for storing various control programs and an RAM 164L (Random Access Memory) for providing a temporarily working area for the processor 161L. For example, the ROM 163L stores programs for setting display positions of the first half-image and the second half-image, determining the voltage (residual quantity) of the second information terminal device 12 and determining to feed a power. Further, image content is stored in the storage section 33L.

If the first information terminal device 11 is connected with the second information terminal device 12 and the terminal sections 18L and 18R are electrically connected with each other, then the control sections 16L and 16R of the first information terminal device 11 and the second information terminal device 12 determine that the two terminals are electrically connected and display the connection on the two-screen display screen. If a connection completion image is displayed, then the user operates the master information terminal device to select and display a desirable image.

In the present embodiment, the image information stored in the storage section of the information terminal device which is determined as a master information terminal device is deemed as the first half-image and the second-half image and then displayed. Further, if desirable image information is not stored in the first information terminal device 11 which is deemed as the master information terminal device but stored in the second information terminal device 12, the operation section 30L or 30R is operated to switch between the master information terminal device and the slave information terminal device.

In the present embodiment, whether or not the connection of the first information terminal device 11 with the second information terminal device 12 is completed is determined by detecting the electric contact of the terminal sections 18L and 18R, however, whether or not the connection of the first information terminal device 11 with the second information terminal device 12 is completed may also be determined using a connection detection switch such as a magnet and a Hall element and the like.

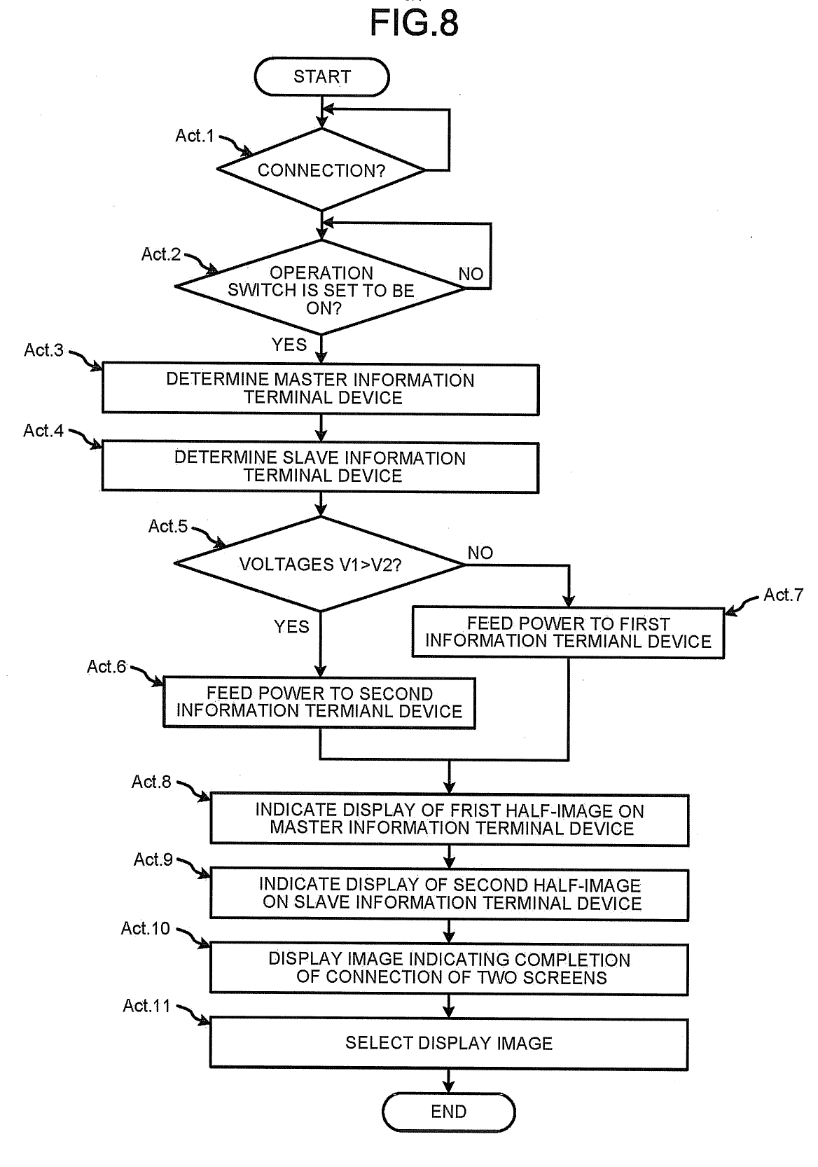

A processing carried out to make it possible to display an image is described based on the flowchart in FIG. 8, wherein the image is displayed based on the two-screen display screen of the display apparatus 10 which is according to the image display circuits shown in FIG. 7.

If the connection of the first information terminal device 11 with the second information terminal device 12 is detected in Act 1, then it proceeds to Act 2.

If the operation switch is set to be ON in Act 2, then it proceeds to Act 3.

The information terminal device the operation switch of which is set to be ON is determined as a master information terminal device in Act 3, and then it proceeds to Act 4.

The information terminal device which is not determined as a master information terminal device is determined as a slave information terminal device in Act 4, and then it proceeds to Act 5.

In Act 5, the voltage (V1) of the battery 17L of the first information terminal device 11 is compared with the voltage (V2) of the battery 17R of the second information terminal device 12. If the voltage V1 is higher than the voltage V2, Act 6 is carried out to determine to feed a power from the battery 17L to the battery 17R. If the voltage V1 is lower than the voltage V2, Act 7 is carried out to determine to feed a power from the battery 17R to the battery 17L, and then Act 8 is carried out.

The master information terminal device is instructed that the first half-image can be displayed in Act 8, and then Act 9 is carried out.

The slave information terminal device is instructed that the second half-image can be displayed in Act 9, and then Act 10 is carried out. An image can be displayed on a two-screen display screen in Act 8 and Act 9.

A connection completion image indicating the completion of the connection of the two screens is displayed in Act 10, and then Act 11 is carried out. For example, as shown in FIG. 6, images 5L an 5R are separately displayed on the first information terminal device 11 and the second information terminal device 12 as a connection completion image, then an image 5 is displayed which is obtained by gradually enlarging the images 5L and 5R into a large connection completion image.

The operator selects a desirable display image and starts the display of an image based on the two-screen display screen in Act 11.

In the present embodiment, the image displayed on the two-screen display screen becomes a seamless image the joint of which is not conspicuous.

If the spine is added in the display apparatus 10, then the apparatus becomes an electronic book type apparatus, and the first information terminal device 11 and the second information terminal device 12 can be used separately when separated from each other or be connected and used together to share a large screen to function as a communication tool.

### Embodiment 2

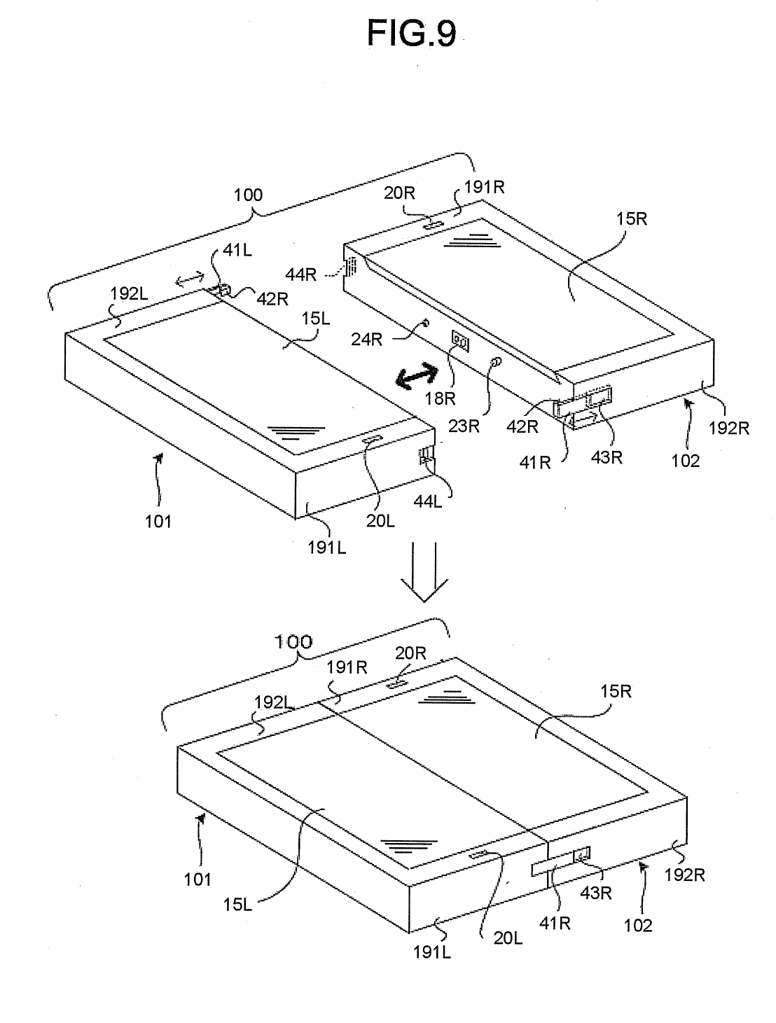

FIG. 9 is a diagram illustrating a display apparatus according to embodiment 2.

In embodiment 2, the display apparatus 100 forms a two-screen display screen by connecting a first information terminal 101 and a second information terminal device 102, which are identical to those described in embodiment 1. The first information terminal device 101 and the second information terminal device 102 are provided with image shifting optical plates 15L and 15R, respectively, and half-images 51L and 51R are displayed on the first information terminal device 101 and the second information terminal device 102, respectively, thereby displaying an image seamlessly. Further, electric circuits of the first information terminal device 101 and the second information terminal device 102 have the same structure shown in the block diagram of FIG. 7. Further, although the magnified image 5 is displayed in FIG. 6, the exemplary magnified image 5 is only illustrative of the obtaining of a seamless image, and the present invention is not limited to obtain a magnified image.

In the present embodiment, in the display apparatus 100, the second information terminal 102 having the same structure with the first information terminal device 101 is vertically reversed with respect to the first information terminal device 101 and is pressed in a direction which faces each other in a sliding manner to carry out positioning and locking and to be connected with the first information terminal device 101.

The first information terminal device 101 and the second information terminal device 102 are positioned through the engagement of the projections 23L and 23R with the engagement holes 24L and 24R.

The first information terminal device 101 and the second information terminal device 102 are fixed through the locking of the locking claws 42R and 42L of the fixing locking members 41R and 41L in the fixing locking holes 44L and 44R.

In the first information terminal device 101, the fixing locking hole 44L is formed on the lateral side of the lower short side section 191L, and the locking claw 42R and 42L is mounted on the upper short side section 192L in the direction indicated by the arrow in a sliding manner.

With reference to the second information terminal device 102, the fixing locking member 41R is arranged in such a manner that the locking member 41R can slide in a sliding groove portion 43R in the direction indicated by the arrow and cannot be pulled out from the upper short side section 192R. The fixing locking members 41L and 41R made from a flexible material such as plastic are elastically deformable, and the locking claws 42R and 42L are fitted into the locking holes 44L and 44R. Further, the locking claws 42R and 42L are pulled out from the fixing locking holes 44L and 44R by pulling the front end of the locking members 41L and 41R up, thereby releasing the locking of the locking claws 42R and 42L to locking holes 44L and 44R. When the first information terminal device 101 and the second information terminal device 102 are used separately, the locking members 41L and 41R are accommodated in the sliding groove portions 43L and 43R (43L is not shown).

Further, the present invention is not limited to use the mechanical fixing method using a locking member and a locking hole.

The embodiments described herein may be embodied in a variety of other forms without departing from the spirit or the main characteristics of the invention. Therefore, these embodiments have been represented by way of example only, and are not intended to limit the interpretation of the invention. The scope of the present invention is that indicated by the scope of the accompanying claims, and not bound by the text of description. Further, all the deformations, various modifications, substitutions and changes included in a scope equivalent to the scope of the accompanying claims are all included in the scope of the present invention.

What is claimed is:

1. An information terminal device provided with a display screen section, comprising:
a flat optical element plate the bottom surface of which is stuck fast to and arranged on the surface of the display screen section to shift the image displayed on the display screen section towards a specific direction and display the shifted image on the top surface of the flat optical element plate as an erected unmagnification image.

2. The information terminal device according to claim 1, wherein
in the optical element plate, fibers, from which the optical element plate is made, are inclined towards a given direction between the bottom surface and the top surface of the optical element plate, and an image is imaged on the top surface.

3. The information terminal device according to claim 1, wherein
if another information terminal device having the same structure is reversed and butted against the information terminal device, then the end edge portion of the optical element plate in an image shifting direction extends to a seamless connection position.

4. The information terminal device according to claim 1, wherein
Terminal sections which are electrically connected with each other when the another information terminal device having the same structure is reversed and connected with the information terminal device and positioning sections for positioning each other are arranged on the lateral side of the end edge portion of the information terminal device in the image shifting direction of the optical element plate.

5. The information terminal device according to claim 1, wherein
a fixing section which fixes another information terminal device having the same structure with the information terminal device and the information terminal device when the another information terminal device is reversed and connected with the information terminal device is arranged on the lateral side of the end edge portion of the information terminal device in the image shifting direction of the optical element plate.

6. The information terminal device according to claim 1, further comprising:
a power supply battery; and
a control section, wherein
the control section comprises a determination section configured to determine which one of the information terminal device and another information terminal device having the same structure with the information terminal device is a master information terminal device for controlling the other one when the another information terminal device is reversed and electrically connected with the information terminal device.

7. The information terminal device according to claim 6, wherein
the control section of the information terminal device determined as a master information terminal device comprises a power feeding determination section configured to compare the voltages of the power supply batteries of the information terminal devices and determine to feed a power from a power supply battery having a high voltage to a power supply battery having a low voltage.

8. The information terminal device according to claim 6, wherein
the control section of the information terminal device determined as a master information terminal device displays an image on a two-screen display screen consisting of display screen sections of the two information terminal devices.

9. A display apparatus for connecting two information terminal devices to form a two-screen display screen, comprising:
a first information terminal device comprising a first flat optical element plate the bottom surface of which is stuck fast to and arranged on the surface of a first display screen section to shift the image displayed on the first display screen section towards an opposite connected terminal device and display the shifted image on the top surface of the first flat optical element plate as an erected unmagnification image; and
a second information terminal device comprising a second flat optical element plate the bottom surface of which is stuck fast to and arranged on the surface of a second display screen section to shift the image displayed on the second display screen section towards an opposite connected terminal device and display the shifted image on the second flat optical element plate as an erected unmagnification image.

10. The display apparatus according to claim 9, wherein
when the first information terminal device is connected with the second information terminal device, the end edges of the first optical element plate and the second optical element plate are seamlessly connected with each other in an image shifting direction.
